(19) United States
(12) Patent Application Publication
(10) Pub. No.: US 2023/0171689 A1
(43) Pub. Date: Jun. 1, 2023

(54) CONTROLLING RADIO MODEM POWER-SAVE MODE

(71) Applicant: NORDIC SEMICONDUTOR ASA, Trondheim (NO)

(72) Inventors: Petri KYNSILEHTO, Oulu (FI); Matti VINNI, Oulu (FI); Veli-Pekka JUNTTILA, Oulu (FI)

(21) Appl. No.: 18/058,495

(22) Filed: Nov. 23, 2022

(30) Foreign Application Priority Data
Nov. 26, 2021 (FI) 20216212

(51) Int. Cl. H04W 52/02

(52) U.S. Cl. CPC H04W 52/0206

(57) ABSTRACT

This document discloses a solution for controlling a power-save mode of a radio modem. According to an aspect, a method comprises by a universal integrated circuit card: triggering an over-the-air update procedure upon receiving a first message via an interface between the universal integrated circuit card and a radio modem; in response to said triggering, transmitting over the interface to the radio modem a second message requesting the radio modem to refrain from entering the power-save mode; receiving, during the over-the-air update procedure, data of the over-the-air update procedure from an over-the-air update platform via the radio modem and via the interface; and upon completing the over-the-air update procedure, indicating allowance of the radio modem to enter the power-save mode.

### TECHNICAL FIELD

Various example embodiments relate to controlling a power-save mode of a radio modem of a cellular communication system.

### BACKGROUND

Power consumption of a modern terminal device of a cellular communication system is a crucial factor. Therefore, many terminal devices employ aggressive power-save modes. For example, Internet-of-Things (IoT) devices are typically low-power devices that are configured to utilize every opportunity to save power. In a power-save mode, a radio modem of the terminal device is typically shut down and its communication capabilities are disabled or suspended. A power-save mode may be controlled by an application processor utilizing the radio modem for data transfer. When the application processor does not require the transfer of data, it may command the radio modem to enter the power-save mode.

However, there are other applications in the terminal device. A universal integrated circuit card (UICC) is a smart card used in the terminal devices. The UICC is operated by applications such as a subscriber identification module (SIM) application or a phone book application. The SIM application contains subscriber identification information to identify a subscriber in a cellular communication system. Different cellular communication systems may use different variations of SIM, e.g. Universal SIM or CDMA SIM. The UICC applications may also require data transfer via the radio modem in, for example, over-the-air updates. If the application processor commands the power-save mode during the over-the-air update, the update is cancelled. If the power-saving is very aggressive, completion of the over-the-air update may get prolonged and, in a worst case scenario, it is possible that the UICC application(s) cannot carry out a successful over-the-air update at all.

### BRIEF DESCRIPTION

According to an aspect, there is provided a method for controlling a power-save mode of a radio modem of a cellular communication system, the method comprising: triggering, in a universal integrated circuit card of the cellular communication system, an over-the-air update procedure upon receiving a first message via an interface between the universal integrated circuit card and the radio modem; in response to said triggering, transmitting by the universal integrated circuit card over the interface to the radio modem, a second message requesting the radio modem to refrain from entering the power-save mode; receiving, by the universal integrated circuit card during the over-the-air update procedure, data of the over-the-air update procedure from an over-the-air update platform via the radio modem and via the interface; and upon completing the over-the-air update procedure, indicating allowance of the radio modem to enter the power-save mode.

An advantage is improved and more efficient over-the-air update procedure due to that the power-save mode of the radio mode is prevented during the update procedure.

In an embodiment, the second message is a response to the first message and dedicated to explicitly command the radio modem to disable the power-save mode. A technical advantage is immediate disabling of the power-save mode, thus enabling completion of the over-the-air update procedure.

In an embodiment, the second message requests the radio modem to open a bearer-independent protocol channel. A technical advantage is utilization of readily available protocol message for controlling the power-save mode, thus providing a less complex implementation.

In an embodiment, a bearer-independent protocol channel is opened between the universal integrated circuit card and the radio modem upon triggering the over-the-air update procedure, wherein the bearer-independent protocol channel is closed upon completing the over-the-air update procedure, wherein said opening the bearer-independent protocol channel comprises transmission of the second message, and wherein said closing the bearer-independent protocol channel comprises said indicating the allowance of the radio modem to enter the power-save mode. A technical advantage is utilization of readily available protocol and messages for controlling the power-save mode, thus providing a less complex implementation.

In an embodiment, the first message is a message of a short message service. The short message thus serves as a trigger for controlling the power-save mode, thus enabling fast control of the power-save mode.

In an embodiment, the method is performed by a subscriber identification module (SIM) application executed on the universal integrated circuit card. An advantage is improved over-the-air update procedure for the SIM application(s).

In an embodiment, the radio modem delivers the request to refrain from entering the power-save mode to an application processor controlling the power-save mode of the radio modem. An advantage is that the application processor is also informed of that the radio modem shall be maintained in an active mode so that the application processor will not command the power-save mode to the radio modem.

In an embodiment, the request to refrain from entering the power-save mode overrules a command from an application processor to the radio modem to enter the power-save mode. This enables the radio modem to maintain the active mode even upon receiving a command to enter the power-save mode from the application processor, thus enabling completion of the over-the-air update procedure.

In an embodiment, the indication of the allowance requests the radio modem to close a bearer-independent protocol channel. A technical advantage is utilization of readily available message for controlling the power-save mode, thus providing a less complex implementation.

According to an aspect, there is provided a universal integrated circuit card of a cellular communication system, comprising means for performing: triggering an over-the-air update procedure upon receiving a first message via an interface between the universal integrated circuit card and a radio modem; in response to said triggering, transmitting over the interface to the radio modem a second message requesting the radio modem to refrain from entering the power-save mode; receiving, during the over-the-air update procedure, data of the over-the-air update procedure from an over-the-air update platform via the radio modem and via the interface; and upon completing the over-the-air update procedure, indicating allowance of the radio modem to enter the power-save mode.

An advantage is improved and more efficient over-the-air update procedure due to that the power-save mode of the radio mode is prevented during the update procedure.

In an embodiment, the second message is associated with a bearer-independent protocol. A technical advantage is utilization of readily available protocol for controlling the power-save mode, thus providing a less complex implementation.

In an embodiment, the second message requests the radio modem to open a bearer-independent protocol channel. A technical advantage is utilization of readily available protocol message for controlling the power-save mode, thus providing a less complex implementation.

In an embodiment, the means are configured to open a bearer-independent protocol channel between the universal integrated circuit card and the radio modem upon triggering the over-the-air update procedure, and to close the bearer-independent protocol channel upon completing the over-the-air update procedure, wherein said opening the bearer-independent protocol channel comprises transmission of the second message, and wherein said closing the bearer-independent protocol channel comprises said indicating the allowance of the radio modem to enter the power-save mode. A technical advantage is utilization of readily available protocol and messages for controlling the power-save mode, thus providing a less complex implementation.

In an embodiment, the first message is a message of a short message service. The short message thus serves as a trigger for controlling the power-save mode, thus enabling fast control of the power-save mode.

In an embodiment, the apparatus comprises a subscriber identification module (SIM) application on the universal integrated circuit card. An advantage is improved over-the-air update procedure for the SIM application(s).

In an embodiment, the indication of the allowance requests the radio modem to close a bearer-independent protocol channel. A technical advantage is utilization of readily available message for controlling the power-save mode, thus providing a less complex implementation.

According to an aspect, there is provided a radio modem of a cellular communication system, comprising means for performing: delivering a first message to a universal integrated circuit card via an interface between the universal integrated circuit card and the radio modem; after delivering the first message, receiving over the interface from the universal integrated circuit card a second message requesting the radio modem to refrain from entering the power-save mode; in response to the second message, performing at least one action for disabling a power-save mode of the radio modem; delivering data of an over-the-air update procedure from an over-the-air update platform to the universal integrated circuit card via the interface; and upon receiving an indication of allowance of the radio modem to enter the power-save mode, performing at least one action for enabling the power-save mode.

In an embodiment, the means are configured to perform the at least one action for disabling a power-save mode of the radio modem by at least indicating said disabling to an application processor, and to perform the at least one action for enabling the power-save mode of the radio modem by at least indicating said enabling to the application processor.

In an embodiment, the means are configured to deliver the request to refrain from entering the power-save mode to an application processor controlling the power-save mode of the radio modem. An advantage is that the application processor is also informed of that the radio modem shall be maintained in an active mode so that the application processor will not command the power-save mode to the radio modem.

In an embodiment, the means are configured to, in response to the request to refrain from entering the power-save mode, overrule a command from an application processor to the radio modem to enter the power-save mode. This enables the radio modem to maintain the active mode even upon receiving a command to enter the power-save mode from the application processor, thus enabling completion of the over-the-air update procedure.

According to an aspect, there is provided a terminal device of a cellular communication system, comprising the universal integrated circuit card and the radio modem described in any one of the above embodiments.

According to an aspect, there is provided a computer program product embodied on a distribution medium readable by a computer and comprising computer program instructions that, when executed by the computer, cause the computer to carry out a computer process comprising: triggering an over-the-air update procedure upon receiving a first message via an interface between a universal integrated circuit card and a radio modem; in response to said triggering, transmitting over the interface to the radio modem a second message requesting the radio modem to refrain from entering the power-save mode; receiving, during the over-the-air update procedure, data of the over-the-air update procedure from an over-the-air update platform via the radio modem and via the interface; and upon completing the over-the-air update procedure, indicating allowance of the radio modem to enter the power-save mode.

According to an aspect, there is provided a computer program product embodied on a distribution medium readable by a computer and comprising computer program instructions that, when executed by the computer, cause the computer to carry out a computer process comprising: delivering a first message to a universal integrated circuit card via an interface between the universal integrated circuit card and the radio modem; after delivering the first message, receiving over the interface from the universal integrated circuit card a second message requesting the radio modem to refrain from entering the power-save mode; in response to the second message, performing at least one action for disabling a power-save mode of the radio modem; delivering data of an over-the-air update procedure from an over-the-air update platform to the universal integrated circuit card via the interface; and upon receiving an indication of allowance of the radio modem to enter the power-save mode, performing at least one action for enabling the power-save mode.

Embodiments are defined in the dependent claims. The scope of protection sought for various embodiments is set out by the independent claims.

The embodiments and features, if any, described in this specification that do not fall under the scope of the independent claims are to be interpreted as examples useful for understanding various embodiments of the invention.

### BRIEF DESCRIPTION OF DRAWINGS

In the following, example embodiments will be described in greater detail with reference to the attached drawings, in which

FIG. 1 illustrates components of a terminal device of a cellular communication system;

FIG. 2 illustrates a procedure for controlling a power-save mode of a radio modem of the cellular communication system;

FIG. 3 illustrates an embodiment of a procedure of FIG. 2; and

FIG. 4 illustrates a process for a radio modem to enable and disable a power-save mode according to an embodiment;

FIG. 5 illustrates another process to enable and disable the power-save mode of the radio modem according to an embodiment.

### DETAILED DESCRIPTION OF SOME EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

FIG. 1 illustrates an embodiment of a terminal device of a cellular communication system in which embodiments described below may be implemented. Referring to FIG. 1, a terminal device may comprise a universal integrated circuit card (UICC) 100 and a radio modem 110. As described in Background, the UICC may refer to a physical circuit on which applications (APP) 102, 104 such as subscriber identification module (SIM) application and a phone book application may run. An application executed on the UICC is in some literature called a card application toolkit (CAT). The UICC may be a detachable SIM card known in the art, or it may be an integral part of the terminal device, e.g. an embedded SIM (eSIM) card or an integrated Universal Integrated Circuit Card (iUICC). The concept of the UICC thus encompasses also eSIMs that may or may not have a card-like physical shape.

The radio modem 110 provides a physical transceiver circuitry capable of communication with one or more base stations of a cellular access network on a physical layer and a link layer for the purpose of delivering data and signalling information between the terminal device and the cellular communication system. The radio modem may further employ a physical radio frequency circuitry in the communication, as known in the art. The radio modem may support one or more cellular communication protocols such as GSM (Global System for Mobile Communications, UMTS (Universal Mobile Telecommunication System), Long-Term Evolution (LTE) or LTE-Advanced, or 5G New Radio. The radio modem 110 is in some standard literature called terminal equipment (TE) or mobile equipment (ME). The radio modem 110 together with the UICC comprising the SIM application may form the terminal device 120. As known in the art, both the radio modem (with the radio frequency front end) and the UICC with the SIM application are needed for transferring data in the cellular communication system.

FIG. 1 further illustrates an application processor 130 executing one or more computer program applications that require transfer of the data by using the terminal device 120. The application processor 130 may in some embodiments also control the power-save mode of the radio modem 110. For example, upon requiring no data transfer services from the radio modem, the application processor 130 may command the radio mode to enter the power-save mode. In the power-save mode, at least some transceiver functions of the radio modem are disabled, thus preventing data transfer with the base station(s) of the cellular access network. As described in Background, entering the power-save mode during the over-the-air (OTA) update of an application of the UICC 100 cancels the update due to that the data transfer of the OTA update is interrupted.

Let us briefly describe the OTA update, although the skilled person is readily familiar with the concept. The OTA update is a technology that updates and changes data in the UICC without having to replace the UICC, e.g. the SIM card. An operator of the cellular access network has an OTA gateway or an OTA platform that operates as a server for the OTA updates. The operator's back-end system sends an OTA update request to the OTA platform to update one or more UICCs. The request may comprise data of the OTA update that shall be delivered to the one or more UICCs for the update. The OTA platform then translates the request into a series of messages of a short message service (SMS) or, alternatively, causes opening of a data bearer with the radio modem. Accordingly, the data of the OTA update is delivered via the series of short messages or over the data bearer to the radio modem which again delivers the data of the OTA update to the UICC.

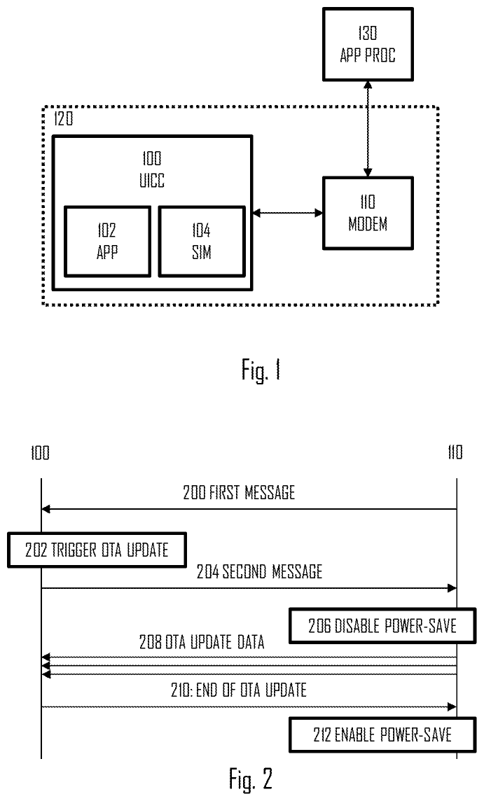

FIG. 2 illustrates a procedure for controlling the power-save mode of the radio modem. FIG. 2 may comprise steps carried out by the UICC 100, e.g. by an UICC application such as the SIM application, and steps carried out by the radio modem 110. Referring to FIG. 2, the method for controlling the power-save mode of the radio modem of the cellular communication system comprises: triggering (block 202), in the UICC, an over-the-air update procedure upon receiving in step 200 a first message via an interface between the UICC 100 and the radio modem 110; in response to said triggering, transmitting (step 204) by the UICC over the interface to the radio modem, a second message requesting the radio modem to refrain from entering the power-save mode; receiving (step 208), by the UICC during the over-the-air update procedure, data of the over-the-air update procedure from an over-the-air update platform via the radio modem and via the interface; and upon completing the over-the-air update procedure, indicating (step 210) allowance of the radio modem to enter the power-save mode.

Upon receiving the second message in step 204, the radio modem performs in block 206 at least one action for disabling a power-save mode of the radio modem. Further embodiments of the at least one function are described below.

Upon receiving in step 210 the indication of allowance of the radio modem to enter the power-save mode, the radio modem performs in block 212 at least one action for enabling the power-save mode. Further embodiments of the at least one function are described below.

The embodiment of FIG. 2 enables completion of the OTA update procedure, thus reducing the number of reattempts of the OTA update. Direct advantages include reduction or even avoidance of unnecessary transfer of data and associated reduction in power consumption of the terminal device 120. A further advantage for a terminal device that has such an aggressive power-saving profile that a conventional OTA update fails (see Background), is that the OTA updates are enabled for the terminal device.

Since the UICC sends the second message as an immediate or direct response to the reception of the first message, the second message may be understood as a proactive or immediate indication of the starting or on-going OTA update procedure, disabling the power-save mode of the radio modem, and the indication of the allowance in step 210 may be understood as an indication of completion of the OTA update procedure.

The power-save mode may be understood as an internal power-saving feature of a device comprising the terminal device, e.g. a sensor device or another type of IoT device. The power-save mode may be controlled by an application processor using the radio modem, unless otherwise specified in the embodiments described herein. In other words, the power-save mode may be logically different from power-save modes of radio connections, e.g. discontinuous reception (DRX) in the cellular communication protocols or a power-save mode of IEEE 802.11 protocols.

In an embodiment, the second message is transmitted associated with a bearer-independent protocol (BIP). The second message may be an OPEN CHANNEL command that requests the radio modem to open a BIP channel with the UICC. Accordingly, the radio modem may, in response to receiving the OPEN CHANNEL command, disable the power-save mode. This embodiment has the advantage that a readily available protocol is used to indicate the need for preventing the power-save mode, thus reducing the complexity of the terminal device.

In an embodiment, the message transferred in step 210 is associated with the BIP. The message may be a CLOSE CHANNEL command that requests the radio modem to close a BIP channel with the UICC. Accordingly, the radio modem may, in response to receiving the CLOSE CHANNEL command, enable the power-save mode. This embodiment has the advantage that a readily available protocol is used to indicate the allowance of the power-save mode, thus reducing the complexity of the terminal device. An embodiment uses the OPEN CHANNEL as the second message of step 204 and CLOSE CHANNEL as the message of step 210.

The OPEN CHANNEL message may be understood as an implicit message for disabling the power-save mode of the radio modem. In an embodiment, the second message is a message dedicated to explicitly request or command to the radio modem to prevent the power-save mode, e.g. DISABLE_POWER_SAVE proactive command. Similarly, the indication of the allowance to enter the power-save mode may be a message dedicated to explicitly allow to the radio modem to enter the power-save mode, e.g. ENABLE_POWER_SAVE proactive command. The messages may be non-standardized messages.

In an embodiment, the second message is a response to the first message, from the UICC to the radio modem. The second message may comprise a status word or response data responsive to the first message in an application protocol data unit (APDU), e.g. a response APDU, wherein the status word or the response data may explicitly request or command the radio modem to prevent the power-save mode. For example, the status word may be COMMAND_OK_DISABLE_POWER_SAVE. Similarly, the indication of the allowance to enter the power-save mode may be a status word or response data in a response APDU from the UICC to any message from the radio modem, wherein the status word or the response data is dedicated to explicitly allow to the radio modem to enter the power-save mode. An example of such a status word is COMMAND_OK_ENABLE_POWER_SAVE. The status words and/or the response data in the response APDUs may be non-standardized messages.

In an embodiment, upon receiving the second message and the indication of the allowance of the power-save mode, the radio modem may forward corresponding information to the application processor as AT commands. An AT command set is known alternatively as a Hayes command set that forms a specific command language where a series of short text strings can be combined to produce commands for controlling a radio modem, e.g. the radio modem 110. Accordingly, the radio modem may communicate with the application processor with respect to enabling and disabling the power-save mode via the AT commands. Respectively, the application processor may command the radio modem to enter the power-save mode by using the AT commands, when the power-save mode is enabled.

Standard literature defines the BIP as a standardized way for the UICC to utilize bearers formed between the radio modem and the base station(s) of the cellular access network to communicate with remote entities such as the OTA update platform. According to the standard literature, a high-level protocol layer called CAT transport protocol is used by a CAT operating on the UICC to communicate with the OTA update platform. The CAT transport protocol employs the BIP as a low-level protocol layer to communicate with the radio modem. The radio modem then performs translation between the BIP and the bearers used for communicating with elements of the cellular access network. The bearer(s) may include one or more of the following bearers to deliver the data of the OTA update between the radio modem and a data gateway of the cellular access network: an evolved packed switched system (EPS) bearer of LTE, and a data bearer of the 5G New Radio. These bearers may employ low-level bearers such radio bearers over which the radio modem delivers the data of the OTA update with the base station(s), as known in the art. The radio modem may translate the data of the OTA update received via the bearer(s) to the BIP. An alternative method for delivering the data of the OTA update is a sequence of messages of a short message service (SMS). The radio modem may deliver the data of the OTA update from the sequence of received SMS messages to the UICC outside the BIP protocol.

In an embodiment, the first message is a message of the SMS. The first message may be the SMS message in a case where the data of the OTA update is fully delivered via the SMS messages between the OTA platform and the radio modem and, additionally, in a case where the data of the OTA update is transferred via data radio bearer(s). The first SMS message may thus serve as the trigger for the OTA update procedure in the UICC. In the case where the data of the OTA update is delivered via the data bearer, the first message may deliver no data but serve as only the trigger of the OTA update procedure in the UICC. the data of the OTA update may be transferred via the data bearer.

In an embodiment, a BIP channel is opened between the UICC and the radio modem upon triggering the over-the-air update procedure, and the BIP channel is closed upon completing the over-the-air update procedure. The opening of the BIP channel may comprise transmission of the second message. The closing of the BIP channel may comprise said indicating the allowance of the radio modem to enter the power-save mode. From the perspective of the radio modem, the radio modem may perform block 206 upon detecting that the UICC has opened the BIP channel, and the radio modem may perform block 212 upon detecting that the UICC has closed the BIP channel. Accordingly, the presence/absence of the BIP channel between the UICC and the radio modem serves as ‘a switch’ for toggling the enablement of the power-save mode.

The method of FIG. 2 may be performed by a SIM application executed on the UICC. Other applications (CATs) of the UICC may equally employ the OTA updates and, thus, perform the procedure of FIG. 2. Some embodiments of FIG. 2 described herein may comprise further steps performed by the radio modem 110 and the application processor 130, for example.

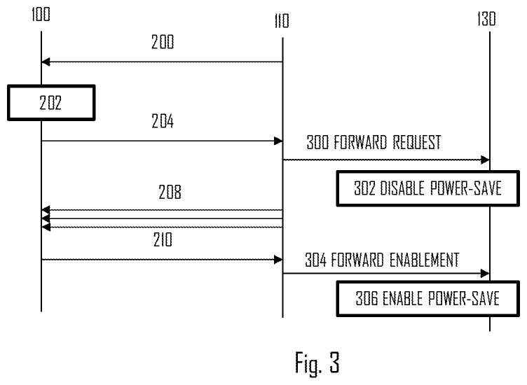

In an embodiment of block 206, upon receiving in step 204 the second message the radio modem autonomously disables the power-save mode. When the power-save mode is disabled by the radio modem, the radio modem ignores a command from the application processor to enter the power-save mode. In other words, the request to refrain from entering the power-save mode overrules the command from the application processor to the radio modem to enter the power-save mode. Similarly, upon receiving the indication of allowance of the power-save mode in step 210, the radio modem autonomously enables the power-save mode again in block 212. When the power-save mode is again enabled by the radio modem, the radio modem follows a command from the application processor to enter the power-save mode. FIG. 3 illustrates another embodiment of blocks 206 and 212. In FIG. 3, the same reference numbers as in FIG. 2 represent the same functions.

Referring to FIG. 3, upon receiving the second message in step 204 the radio modem delivers (step 300) the request to refrain from entering the power-save mode to the application processor controlling the power-save mode of the radio modem. Since the interface with the UICC is different from the interface with the application processor, the radio modem may perform a translation operation to translate the request suitable for delivery to the application processor. Upon receiving the request, the application processor may disable (block 302) the power-save mode of the radio modem. The application processor may suspend commanding the radio modem to enter the power-save mode. Accordingly, if the application processor has a situation where it has no need for the radio modem and would conventionally command the power-save mode, the application processor would not send the command during the suspension. Similarly, upon receiving the indication of allowance of the power-save mode in step 210, the radio modem delivers (step 304) the indication to the application processor. Upon receiving the indication in step 304, the application processor may remove the suspension (block 306) and enable the power-save mode for the radio modem.

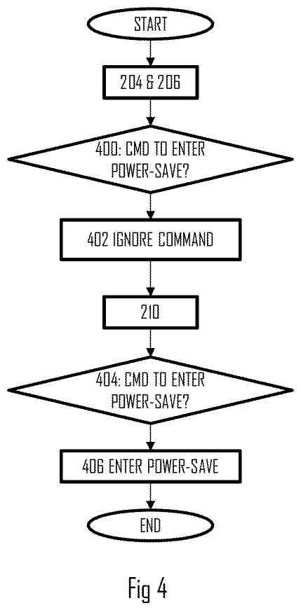

FIG. 4 illustrates an embodiment of a procedure for the radio modem to manage the commands from the application processor in the embodiment where the radio modem autonomously determines whether or not to enter the power-save mode. Referring to FIG. 4, upon receiving the request to stay in an active mode (i.e. not to enter the power-save mode) in step 204 and performing block 206, the radio modem detects in block 400 a command from the application processor to enter the power-save mode. Since the power-save mode is currently disabled as a result of block 206, the radio modem ignores the command, responds to the application processor that the radio modem cannot enter the power-save mode, or stores the command to be executed upon enabling the power-save mode again (block 402). Upon enabling the power-save mode again in block 210, the radio modem determines in block 404 whether or not the application processor has commanded the power-save mode. If it is determined that the application processor has issued the command, e.g. upon receiving the command in block 400 or upon receiving a new command to enter the power-save mode, the radio modem enters the power-save mode in block 406. Otherwise, the process may end.

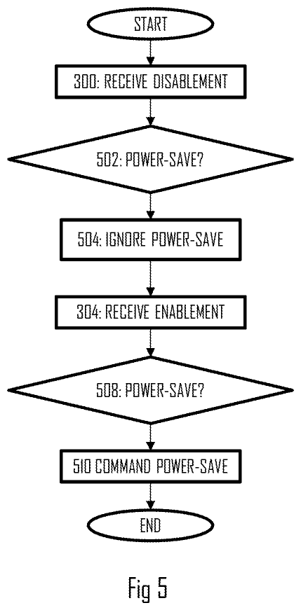

FIG. 5 illustrates an embodiment of a procedure for the application processor for managing the power-save mode of the radio modem. FIG. 5 illustrates an embodiment of the operation of the application processor 130 in steps 300 to 306. Upon receiving the forwarded information about the on-going OTA procedure and corresponding disabling the power-save mode, e.g. in step 300, the application processor may disable the power-save mode of the radio modem. At this stage, the application processor may then output an indicator to a user via a user interface of an apparatus comprising the radio modem and the application processor. The apparatus may be a mobile phone, a tablet computer, or a sensor device, for example. The indicator may be a visual indicator, and audio output, or a haptic output. The indication may indicate to the user that the power-save mode is currently unavailable. As a consequence, upon detecting a condition triggering the power-save mode in block 502, the application processor refrains from commanding the radio modem to enter the power-save mode in block 504. Similarly, upon receiving in step 304 the forwarded information about the completed OTA procedure and corresponding enabling the power-save mode, the application processor may enable the power-save mode of the radio modem. As a consequence, upon detecting a condition triggering the power-save mode in block 508, the application processor commands the radio modem to enter the power-save mode in block 510.

From another perspective, an embodiment comprises a UICC 100 comprising means for performing: triggering an over-the-air update procedure upon receiving a first message via an interface between the UICC and a radio modem; in response to said triggering, transmitting over the interface to the radio modem a second message requesting the radio modem to refrain from entering the power-save mode; receiving, during the over-the-air update procedure, data of the over-the-air update procedure from an over-the-air update platform via the radio modem and via the interface; and upon completing the over-the-air update procedure, indicating allowance of the radio modem to enter the power-save mode.

The means may be realized by at least one processor or a processing circuitry and at least one memory storing at least one computer program application comprising computer program instructions for carrying out the steps of the UICC described above.

From another perspective, an embodiment provides a radio modem 110 of a cellular communication system, comprising means for performing: delivering a first message to a UICC via an interface between the UICC and the radio modem; after delivering the first message, receiving over the interface from the UICC a second message requesting the radio modem to refrain from entering the power-save mode; in response to the second message, performing at least one action for disabling a power-save mode of the radio modem; delivering data of an over-the-air update procedure from an over-the-air update platform to the UICC via the interface; and upon receiving an indication of allowance of the radio modem to enter the power-save mode, performing at least one action for enabling the power-save mode.

The means may be realized by at least one processor or a processing circuitry and at least one memory storing at least one computer program application comprising computer program instructions for carrying out the steps of the radio modem described above.

As described above, the process of FIG. 2 or any one of the embodiments thereof may comprise functions executed by the UICC, functions executed by the radio modem, and communication between the UICC and the radio modem. In an embodiment, the functions of FIG. 2 are performed by a processing system of the UICC and a processing system of the radio modem. Each processing system may comprise at least one processor and at least one memory comprising a computer program code readable by the at least one processor. The computer program code may form a computer program product defining a computer process executed by the at least one processor, when the at least one processor reads and executes the computer program code.

As used in this application, the term ‘circuitry’ refers to one or more of the following: hardware-only circuit implementations such as implementations in only analogue and/or digital circuitry; combinations of hardware circuits and software and/or firmware; and circuits such as a microprocessor(s) or a portion of a microprocessor(s) that require software or firmware for operation, even if the software or firmware is not physically present. This definition of ‘circuitry’ applies to uses of this term in this application. As a further example, as used in this application, the term “circuitry” would also cover an implementation of merely a processor (or multiple processors) or portion of a processor, e.g. one core of a multi-core processor, and accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described in FIG. 2 or any of the embodiments thereof may also be carried out in the form of one or more computer processes defined by one or more computer programs. The computer program(s) may be in source code form, object code form, or in some intermediate form, and it may be stored in a carrier or a distribution medium, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

Embodiments described herein are applicable to systems defined above but also to other systems. The protocols used, the specifications of the systems and their elements develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. Embodiments are not limited to the examples described above but may vary within the scope of the claims.

1. A method for controlling a power-save mode of a radio modem of a cellular communication system, the method comprising:
triggering, in a universal integrated circuit card of the cellular communication system, an over-the-air update procedure upon receiving a first message via an interface between the universal integrated circuit card and the radio modem;
in response to said triggering, transmitting by the universal integrated circuit card over the interface to the radio modem, a second message requesting the radio modem to refrain from entering the power-save mode;
receiving, by the universal integrated circuit card during the over-the-air update procedure, data of the over-the-air update procedure from an over-the-air update platform via the radio modem and via the interface; and
upon completing the over-the-air update procedure, indicating allowance of the radio modem to enter the power-save mode.

2. The method of claim 1, wherein the second message is a response to the first message and dedicated to explicitly command the radio modem to disable the power-save mode.

3. The method of claim 1, wherein the second message requests the radio modem to open a bearer-independent protocol channel.

4. The method of claim 1, wherein a bearer-independent protocol channel is opened between the universal integrated circuit card and the radio modem upon triggering the over-the-air update procedure, wherein the bearer-independent protocol channel is closed upon completing the over-the-air update procedure, wherein said opening the bearer-independent protocol channel comprises transmission of the second message, and wherein said closing the bearer-independent protocol channel comprises said indicating the allowance of the radio modem to enter the power-save mode.

5. The method of claim 1, wherein the first message is a message of a short message service.

6. The method of claim 1, wherein the method is performed by a subscriber identification module application executed on the universal integrated circuit card.

7. The method of claim 1, wherein the radio modem delivers the request to refrain from entering the power-save mode to an application processor controlling the power-save mode of the radio modem.

8. The method of claim 1, wherein the request to refrain from entering the power-save mode overrules a command from an application processor to the radio modem to enter the power-save mode.

9. The method of claim 1, wherein the indication of the allowance requests the radio modem to close a bearer-independent protocol channel.

10. A universal integrated circuit card of a cellular communication system, comprising at least one processor and at least one memory storing at least one computer program application comprising computer program instructions for performing:
triggering an over-the-air update procedure upon receiving a first message via an interface between the universal integrated circuit card and a radio modem;
in response to said triggering, transmitting over the interface to the radio modem a second message requesting the radio modem to refrain from entering the power-save mode;
receiving, during the over-the-air update procedure, data of the over-the-air update procedure from an over-the-air update platform via the radio modem and via the interface; and
upon completing the over-the-air update procedure, indicating allowance of the radio modem to enter the power-save mode.

11. A radio modem of a cellular communication system, comprising at least one processor and at least one memory storing at least one computer program application comprising computer program instructions for performing:
delivering a first message to a universal integrated circuit card via an interface between the universal integrated circuit card and the radio modem;
after delivering the first message, receiving over the interface from the universal integrated circuit card a second message requesting the radio modem to refrain from entering the power-save mode;
in response to the second message, performing at least one action for disabling a power-save mode of the radio modem;
delivering data of an over-the-air update procedure from an over-the-air update platform to the universal integrated circuit card via the interface; and
upon receiving an indication of allowance of the radio modem to enter the power-save mode, performing at least one action for enabling the power-save mode.

12. The radio modem of claim 11, wherein the at least one processor and the at least one memory storing the at least one computer program application comprising the computer program instructions are configured to perform the at least one action for disabling a power-save mode of the radio modem by at least indicating said disabling to an application processor, and to perform the at least one action for enabling the power-save mode of the radio modem by at least indicating said enabling to the application processor.

13. A terminal device of a cellular communication system, comprising:
a universal integrated circuit card of a cellular communication system, comprising at least one processor and at least one memory storing at least one computer program application comprising computer program instructions for performing:
triggering an over-the-air update procedure upon receiving a first message via an interface between the universal integrated circuit card and a radio modem;
in response to said triggering, transmitting over the interface to the radio modem a second message requesting the radio modem to refrain from entering the power-save mode;
receiving, during the over-the-air update procedure, data of the over-the-air update procedure from an over-the-air update platform via the radio modem and via the interface; and
upon completing the over-the-air update procedure, indicating allowance of the radio modem to enter the power-save mode; and
a radio modem of a cellular communication system, comprising at least one processor and at least one memory storing at least one computer program application comprising computer program instructions for performing:
delivering a first message to a universal integrated circuit card via an interface between the universal integrated circuit card and the radio modem;
after delivering the first message, receiving over the interface from the universal integrated circuit card a second message requesting the radio modem to refrain from entering the power-save mode;
in response to the second message, performing at least one action for disabling a power-save mode of the radio modem;
delivering data of an over-the-air update procedure from an over-the-air update platform to the universal integrated circuit card via the interface; and
upon receiving an indication of allowance of the radio modem to enter the power-save mode, performing at least one action for enabling the power-save mode.

14. A non-transitory computer program product embodied on a distribution medium readable by a computer and comprising computer program instructions that, when executed by the computer, cause the computer to carry out a computer process comprising:
triggering an over-the-air update procedure upon receiving a first message via an interface between the universal integrated circuit card and a radio modem;
in response to said triggering, transmitting over the interface to the radio modem a second message requesting the radio modem to refrain from entering the power-save mode;
receiving, during the over-the-air update procedure, data of the over-the-air update procedure from an over-the-air update platform via the radio modem and via the interface; and
upon completing the over-the-air update procedure, indicating allowance of the radio modem to enter the power-save mode.

15. A non-transitory computer program product embodied on a distribution medium readable by a computer and comprising computer program instructions that, when executed by the computer, cause the computer to carry out a computer process comprising:
delivering a first message to a universal integrated circuit card via an interface between the universal integrated circuit card and the radio modem;
after delivering the first message, receiving over the interface from the universal integrated circuit card a second message requesting the radio modem to refrain from entering the power-save mode;
in response to the second message, performing at least one action for disabling a power-save mode of the radio modem;
delivering data of an over-the-air update procedure from an over-the-air update platform to the universal integrated circuit card via the interface; and
upon receiving an indication of allowance of the radio modem to enter the power-save mode, performing at least one action for enabling the power-save mode.
